(19) United States
(12) Patent Application Publication
(10) Pub. No.: US 2008/0084686 A1
(43) Pub. Date: Apr. 10, 2008

(54) ELECTROLUMINESCENCE-EQUIPPED ARTICLE

(75) Inventors: Andreas Gutsch, Ludinghausen (DE); Michael Schulze, Dulmen / Buldern (DE); Gerhard Geipel, Haltern am See (DE); Rolf Krause, Gladbeck (DE)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA GmbH, Duesseldorf (DE)

(21) Appl. No.: 11/853,176

(22) Filed: Sep. 11, 2007

(30) Foreign Application Priority Data
Oct. 9, 2006 (DE) 202006015495.7

(51) Int. Cl. F21V 9/16; H01J 1/62

(52) U.S. Cl. 362/84; 313/483

(57) ABSTRACT

An electroluminescent unit, containing a) an energy source; b) an electronic drive; and c) at least one electroluminescent film in a transparent sheath are useful in illuminated articles, in particular transport containers and items for everyday use.

### BACKGROUND OF THE INVENTION

1. Field of the Invention

The present invention relates to electroluminescent units and articles equipped with them.

2. Discussion of the Background

Electroluminescent films are described in detail in the literature. Such electroluminescent films include the required energy sources and electronic circuits, inverters constructed in a microminiaturized or discrete form, which produce the AC voltage required for operation of the electroluminescent films, as well as further electronic circuits for various operating modes of the electroluminescent films.

For example, DE 296 00 047 U1 discloses a visual safety and signaling device in which an electroluminescent film is powered by a battery, to which an inverter and a controller, to which a control unit can be added, are connected. By way of example, a jacket or, in an entirely general form, safety clothing, can be equipped with a device such as this. The components of this device are fitted individually to the piece of clothing, in particular the electroluminescent indication layer being sewn to the item of clothing, or being fixed on it, by means of a transparent film. This equipment has the disadvantage of a large amount of effort required to fit each individual part to the piece of clothing, in order to ensure portability. The connecting cables between the components of the device must be drawn through the piece of clothing, or must be sewn to it, which requires effort. The seams by means of which the electroluminescent films are fixed to the piece of clothing can be made waterproof or weather-resistant in general only with particular additional effort, and electroluminescent films are not weather-resistant per se. The life of an electroluminescent device such as this on pieces of clothing can be achieved only with a large amount of additional effort. However, safety clothing is in fact frequently subject to severe conditions during use, and the life of a device such as this is therefore restricted, or even unsatisfactory, owing the poor resistance to wear.

DE 295 17 078 U1 describes electroluminescent buttons or films in the form of safety imaging or decorative imaging with various motifs, which can be attached to various pieces of clothing or to satchels by means of a Velcro fastener or clip. This document also describes the electroluminescent film and the components which are required to operate it being protected against weather influences only by means of a transparent cover, and being mounted discretely. In addition, the energy source is connected by means of a clamping or plug-in apparatus, which restricts the robustness of this type of assembly and makes it susceptible to wear, in terms of the clamping and plug-in connections becoming loose or dirty. Continuous availability of the power supply can admittedly be ensured by means of mains connection or by the capability to replace the battery. However, a procedure such as this in the first case restricts the mobility and portability of the object equipped in this way, or, in the second case, is becoming increasingly undesirable nowadays in terms of the requirements for environmental protection and resource conservation.

EP 0 350 907 B1 discloses an electroluminescent thin-film panel, in which a thin-film electroluminescent display is made insensitive to moisture originating from the outside, by means of plastic layers with vapor blocking characteristics. This apparatus is adhesively bonded to a base plate. The disadvantage of this arrangement is that it has little flexibility, or lacks flexibility, restricting use to items of everyday use which are likewise inflexible.

### SUMMARY OF THE INVENTION

It is one object of the present invention to provide electroluminescent articles which overcome one or more of the above disadvantages.

This object has been surprisingly achieved by an electroluminescent unit, comprising:
a) an energy source;
b) an electronic drive; and
c) at least one electroluminescent film in a transparent sheath.

In another embodiment, the present invention relates to an illuminated article, comprising the above electroluminescent unit.

### BRIEF DESCRIPTION OF DRAWINGS

FIG. 1 shows a schoolbag, in the form of a photograph of the front, having an electroluminescent unit (1).

FIG. 2 shows the same schoolbag in a view from the side having a further electroluminescent unit (2).

### DETAILED DESCRIPTION OF THE INVENTION

The present invention relates to an electroluminescent unit comprising an energy source, an electronic drive, and at least one electroluminescent film in a transparent sheath.

For the purposes of the present invention, an “electroluminescent unit” should be understood as meaning an arrangement which has the components required for operation of an electroluminescent film or films, has the electroluminescent film or films, and has a transparent sheath which sheathes all of the components as well as the electroluminescent films jointly.

The components which are required for operation of the electroluminescent film or films, such as
electroluminescent film or films,
energy source,
electronic drive, comprising
   DC/AC inverter and electronic ON/OFF switch or switches,
electronic charging apparatus or unit,
connecting cable or cables,
   may be combined in a transparent sheath.

An illuminated article may comprise the electroluminescent unit according to the invention.

The electroluminescent unit according to the invention may be weather-resistant and watertight, and can be fitted to, or integrated in, objects of all types in a simple manner.

In one embodiment, there is no need for discrete and/or additional laying, attachment and/or integration of the connecting cables between the components of the electroluminescent unit according to the invention on or in the material of the illuminated article according to the invention, which saves costs. The illuminated article according to the invention may consist entirely of the electroluminescent unit according to the invention, which gives an illuminated article such as this particular visual appeal during use.

The subject matter of the present invention will be described by way of example in the following text without being intended to be restricted to this.

The electroluminescent unit according to the invention may have one or more electroluminescent films. If the electroluminescent unit has a plurality of films, then the shapes of the electroluminescent films may be the same or different. The electroluminescent films may be arranged one above the other or alongside one another. This makes it possible to represent different symbols, shapes or images. The shape of the film of the electroluminescent unit according to the invention may, for example, be chosen from the group of symbols, geometric shapes, images, written characters or a combination of these shapes. The symbols may be chosen from the group of icons, company logos, information signs, stylized images, direction signs, in which case the direction signs may be chosen from arrows, or a combination of these symbols.

It is preferable for the shapes to be provided from cut-out electroluminescent films or electroluminescent films printed with a translucent or opaque ink, or translucent or opaque inks.

The electroluminescent films for the electroluminescent unit may preferably have illuminated colored layers with colors chosen from red, yellow, green, blue or a combination of these colors or shades in between these colors or shades obtained by mixing of these colors, with the colors being the same or different. It is particularly preferable for the electroluminescent films of the electroluminescent unit to have illuminated colored layers of any color, in which case the color may be obtained by additive mixing of the primary colors red, green and blue. Furthermore, the colors of the electroluminescent films can particularly preferably be chosen to be different, with these films being arranged one above the other. This allows symbols of different colors to be presented.

The distances between electroluminescent films which are arranged alongside one another may be the same or different. The distances between electroluminescent films which are arranged above one another may be the same or different. Such distance may be obtained by the use of one or more spacers.

Any suitable energy source may be used as the energy source. Batteries, photovoltaic cells or combinations of them can preferably be used. The energy source of the electroluminescent unit according to the invention can preferably be chosen from non-rechargeable batteries or rechargeable batteries, chosen from the group of NiCd batteries, NiMH batteries, lithium-ion batteries, photovoltaic cells, or a combination of these energy sources. It is particularly advantageous for the energy source to be a rechargeable battery, for example a lithium-ion battery. It is very particularly advantageous for the energy source to be a rechargeable battery, preferably a rechargeable lithium-ion battery, in conjunction with a photovoltaic cell via which the battery can be charged again from incident daylight or artificial light. Furthermore, it may be very particularly advantageous for the battery or the rechargeable battery to have a flat shape, in which case the thickness of the battery or of the rechargeable battery can be chosen to be from 0.5 to 10 mm, preferably from 1 to 8 mm, and particularly preferably from 3 to 6 mm.

The electronic drive for the electroluminescent unit may have an inverter and induction charging unit. The advantage of this electronic drive is that the electroluminescent unit can be recharged by means of induction charging, while at the same time ensuring the portability of this electroluminescent unit and improving the availability of the electroluminescent unit in comparison to a conventional electroluminescent unit. It is particularly advantageous for the electronic drive for the electroluminescent unit according to the invention to have a rechargeable battery, preferably lithium-ion battery, in conjunction with a photovoltaic cell and induction charging. Furthermore, it is particularly advantageous for the type of electronic drive for the electroluminescent unit according to the invention to be chosen from a miniaturized shape, preferably a flat miniaturized shape, in which case the thickness of this electronic drive may be chosen to be from 0.5 to 10 mm, preferably from 1 to 8 mm, and particularly preferably from 3 to 6 mm.

It may also be advantageous for the electronic ON/OFF switch for the electronic drive for the electroluminescent unit according to the invention to have a sensor, preferably a heat-sensitive, light-sensitive, pressure-sensitive or acceleration-sensitive sensor, by means of which the electroluminescent unit according to the invention can be activated and deactivated.

It may also be advantageous for the electronic drive for the electroluminescent unit according to the invention to have a circuit by means of which the electroluminescent unit according to the invention can be activated and deactivated in an automatically changing form, in which case the electroluminescent film or the electroluminescent films for the electroluminescent unit according to the invention may emit light on a flashing cycle. If the electroluminescent unit according to the invention has a plurality of electroluminescent films, it may also be advantageous to have the capability of the flashing cycles of the electroluminescent films to be the same or different.

The sheath for the electroluminescent unit according to the invention is a transparent plastic layer. This transparent plastic layer can optionally be chosen from the group of transparent polymers. The sheath for the electroluminescent unit may preferably have or comprise polypropylene, polyethylene, polymethyl methacrylate or a combination of these polymers.

The sheath may be provided by heat sealing, adhesively bonding, winding or encapsulating the electroluminescent unit in a transparent plastic layer. The transparent plastic layer may have a thickness over the electroluminescent film or over each electroluminescent film of from 0.01 to 5 mm, preferably from 0.02 to 4 mm, furthermore preferably from 0.03 to 3 mm, particularly preferably from 0.05 to 1 mm, and very particularly preferably from 0.1 to 0.75 mm. The thickness of the transparent plastic layer includes all values and subvalues therebetween, especially including 0.05, 0.1, 0.5, 1, 1.5, 2, 2.5, 3, 3.5, 4 and 4.5 mm.

It may be advantageous for the transparent plastic film for the electroluminescent unit according to the invention to be chosen from a laminate film, in which case the electroluminescent unit may be heat sealed in between two or more laminate films.

It may also be advantageous for the sheath for the electroluminescent unit to be closed on all sides. At this point and in the following text, the expression a sheath which is “closed on all sides” should be understood as meaning a sheath which sheathes the energy source, the electronic drive, and the electroluminescent film or, if the electroluminescent unit has a plurality of electroluminescent films, the electroluminescent films, in a closed surface.

The electronic components of this electroluminescent unit do not make direct physical contact with the environment. However, other embodiments are possible, which include contact of the electronic units with the environment. The electroluminescent unit is weather-resistant and watertight, particularly if the sheath is closed on all sides. The sheath for the electrical components of this electroluminescent unit is proof against direct contact. In another embodiment, the electroluminescent unit likewise has the further advantage of better mechanical protection than in the conventional units, and the further advantage of longer life and greater operational reliability. In one embodiment, the electroluminescent unit likewise has the advantage of better protection than the conventional units against direct contact with electrically live components.

It may also be advantageous for the sheath of the electroluminescent unit to have a rim. The expression “width of the rim” at this point and in the following text should be understood as meaning the dimension measured on a plane at right angles to the thickness of the transparent plastic layer, above the electroluminescent film. The width of the rim can advantageously be chosen to be from 0.5 mm to 3 cm, preferably from 1 mm to 2 cm, and particularly preferably from 2 mm to 1 cm. The width of the rim includes all values and subvalues therebetween, especially including 1 mm, 2, 3, 4, 5, 6, 7, 8, 9, 1 cm, 1.5, 2 and 2.5 cm.

The subject matter of the present invention also covers an illuminated article, which is characterized in that the illuminated article has or comprises the electroluminescent unit according to the invention.

The illuminated article according to the invention may, for example, be a transport container or an item for everyday use. The illuminated article is not particularly limited.

The illuminated article according to the invention may be chosen from the group comprising bags, satchels, sacks, rucksacks, cases, covers, clothing, sports equipment, underwater boards, books, menu cards, programs, umbrellas, furniture, safety clothing, worktops, machine housings, bodywork, railway partition walls, goods-vehicle casings, tanker wagons, ship hulls, aircraft fuselages, wings, doors and children's toys. The children's toy can advantageously be chosen from the group comprising model aircraft, model cars, items for model kits, doll's houses, model railways and yoyos.

Sporting equipment may, for example, be items of clothing or objects which are worn by skiers, divers, mountain climbers, walkers, for trekking or for jogging, or by cyclists, or be worn as clothing or equipment. Clothing may, for example, be items of clothing for everyday use, as well as fancy dress, theatre costumes, costumes for the visual arts, or recreational clothing.

The illuminated article may also be chosen from schoolbags, cyclists' bags, walking bags, golf bags, shopping bags, or cases, and may also be chosen from the group comprising CD sleeves, HDCD sleeves, DVD sleeves, DVD audio sleeves, record sleeves, compact-disc holders, compact-disc carousels, plastic bags, bottles, shampoo bottles, drinks bottles, bottles for hazardous substances, compressed-gas containers, boilers, suitcases, trunks, cabinets, business cases, bags and handbags.

It may also be advantageous for the material of the illuminated article according to the invention to be sewn, screwed, adhesively bonded, connected by means of Velcro strip, pushed into a tongue and groove connection, plugged in, clamped or welded to the rim of the sheath of the electroluminescent unit. The material for the illuminated article according to the invention may be chosen from the group comprising wood, leather, glass, metal, metal alloy, plastic, rubber, artificial rubber, textile fabric, and/or further electroluminescent units, preferably 1, 2, 3, 4, 5 or 6 further electroluminescent units, or a combination of these materials. If the material for the illuminated article is chosen to be a textile fabric, it may be advantageous for this textile fabric to be chosen from fabric, non-woven, knitted fabrics or a combination of these fabrics.

The following illustrations are intended to explain the illuminated article according to the invention in more detail without the intention of restricting the invention to these embodiments.

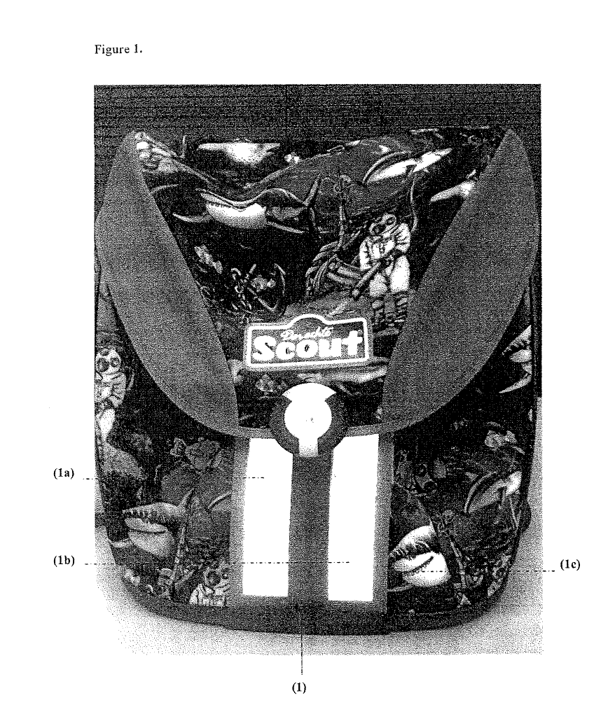

FIG. 1 shows a schoolbag of the Scout type, from Alfred Sternjakob GmbH & Co. KG, in the form of a photograph of the front, having an electroluminescent unit (1) according to the invention. At its edge (1c), this electroluminescent unit is incorporated in the front fastening strap, and has two electroluminescent films (1a) and (1b), separated from one another.

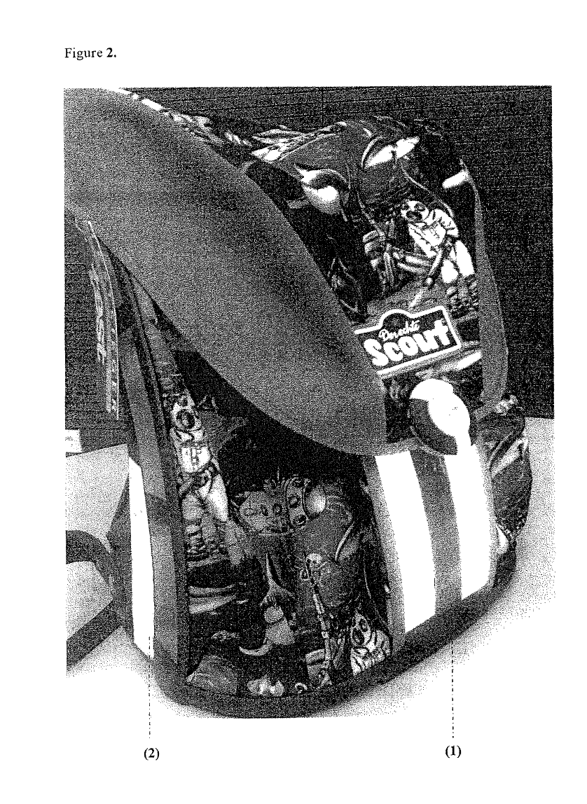

FIG. 2 shows the same schoolbag in a view from the side at the front. A further electroluminescent unit (2) is incorporated in the side body of the schoolbag, and has one electroluminescent film.

German patent application 20 2006 015 495.7 filed Oct. 9, 2006, is incorporated herein by reference.

Numerous modifications and variations on the present invention are possible in light of the above teachings. It is therefore to be understood that within the scope of the appended claims, the invention may be practiced otherwise than as specifically described herein.

1. An electroluminescent unit, comprising:
a) an energy source;
b) an electronic drive; and
c) at least one electroluminescent film in a transparent sheath.

2. The electroluminescent unit according to claim 1, comprising a plurality of electroluminescent films;
wherein the shapes of the electroluminescent films are the same or different.

3. The electroluminescent unit according to claim 1, wherein the shape of the electroluminescent film is selected from the group consisting of symbols, geometric shapes, images, written characters or a combination of these shapes.

4. The electroluminescent unit according to claim 1, wherein the electroluminescent film has illuminated colored layers with colors selected from the group consisting of red, yellow, green, blue or a combination of these colors, wherein the colors may be the same or different.

5. The electroluminescent unit according to claim 2, wherein the distances between the electroluminescent films are the same or different.

6. The electroluminescent unit according to claim 1, wherein the energy source is selected from the group consisting of NiCd batteries, NiMH batteries, lithium-ion batteries, photovoltaic cells, or a combination of these energy sources.

7. The electroluminescent unit according to claim 1, wherein the electronic drive comprises an inverter and induction charging unit.

8. The electroluminescent unit according to claim 1, wherein the sheath is a transparent plastic layer.

9. The electroluminescent unit according to claim 1, wherein the sheath is closed on all sides.

10. An electroluminescent unit according to claim 1, wherein the sheath has a rim.

11. An illuminated article, comprising the electroluminescent unit according to claim 1.

12. The illuminated article according to claim 11, which is a transport container or an item for everyday use.

13. The illuminated article according to claim 11, wherein the illuminated article is selected from the group consisting of bags, satchels, sacks, rucksacks, cases, covers, clothing, sports equipment, underwater boards, books, menu cards, programmes, umbrellas, furniture, safety clothing, worktops, machine housings, bodywork, railway partition walls, goods-vehicle casings, tanker wagons, ship hulls, aircraft fuselages, wings, doors and children's toys.

14. The illuminated article according to claim 13, wherein the childrens' toy is selected from the group consisting of model aircraft, model cars, items for model kits, doll's houses, model railways and yoyos.

15. The illuminated article according to claim 11, wherein a material of the illuminated article is sewn, screwed, adhesively bonded, connected by means of Velcro strip, pushed into a tongue and groove connection, plugged in, clamped or welded to the rim of the sheath of the electroluminescent unit.

16. The illuminated article according to claim 11, wherein a material of the illuminated article is selected from the group consisting of wood, leather, glass, metal, plastic, textile fabric, and/or further electroluminescent units, or a combination of these materials.

17. The illuminated article according to claim 16, comprising a textile fabric which is selected from the group consisting of fabric, non-woven, knitted fabrics or a combination of these fabrics.
